(19) United States
(12) Patent Application Publication
(10) Pub. No.: US 2014/0327172 A1
(43) Pub. Date: Nov. 6, 2014

(54) BLOCK COPOLYMER FILM AND METHOD OF PRODUCING THE SAME

(71) Applicant: CANON KABUSHIKI KAISHA, Tokyo (JP)

(72) Inventors: Kazuhiro Yamauchi, Suntou-gun (JP); Kenji Yamada, Yokohama-shi (JP); Mamiko Kumagai, Yokohama-shi (JP); Kyoko Kumagai, Mishima-shi (JP)

(21) Appl. No.: 14/332,901

(22) Filed: Jul. 16, 2014

Related U.S. Application Data
(62) Division of application No. 12/991,974, filed on Nov. 10, 2010.

(30) Foreign Application Priority Data
May 30, 2008 (JP) 2008-143456

(51) Int. Cl. B29D 7/01

(52) U.S. Cl. CPC B29D 7/01; B29K 2096/04
USPC 264/148

(57) ABSTRACT

Provided is a block copolymer film in which a microphase separation structure formed by a block copolymer is arranged perpendicularly to the film surface, and all components forming the block copolymer are uncovered to the film surface, whereby the microphase separation structure penetrates the film surface. A method of producing the block copolymer film includes the steps of extruding a melt of the block copolymer in one direction by extrusion molding or injection molding, cooling the extruded block copolymer to a temperature equal to or lower than glass transition temperatures of polymer components in the block copolymer to provide a prismatic or cylindrical extrusion molded product, and cutting the prismatic or cylindrical extrusion molded product in the direction perpendicular to the extrusion direction.

### TECHNICAL FIELD

The present invention relates to a block copolymer film in which a microphase separation structure is oriented in a direction perpendicular to a film surface, and a method of producing the film.

### BACKGROUND ART

Polymer functional films having a nanometer-scale channel structure have been expected to find applications in a variety of fields including electronics, photonics, biotechnology, energy savings, and environmental protection. One example of the polymer functional films is a polymer functional film utilizing a microphase separation structure of a block copolymer.

A block copolymer obtained by connecting the terminals of two or more kinds of chain polymers through covalent bonds causes phase separation due to repulsive interaction acting between dissimilar polymers, and then the polymer chains of the same kind agglomerate. However, a phase separation structure larger than the spread of each polymer chain cannot be produced owing to the connectivity between the dissimilar polymer chains, with the result that a periodic self-organizing structure ranging from a nanometer scale to a mesoscopic scale is produced. The nanometer-scale periodic structure obtained by this process is referred to as “microphase separation structure.”

As disclosed in Bates, F. S.; Fredrickson, G. H.; Annu. Res. Phys. Chem. 1990 (41) 525, the microphase separation structures formed by the block copolymer show morphologies such as a spherical structure, a cylindrical structure, a bicontinuous structure, and a lamellar structure. Each of those morphologies can be arbitrarily controlled depending on the composition of the components and the repulsive interaction acting between the components.

When the microphase separation structures formed from a block copolymer are utilized in a functional film, it is desirable that components forming a channel structure are uncovered to the surface of the film and are arranged in the direction perpendicular to the film surface, in other words, arranged so as to penetrate the film surface. In ordinary cases, however, the microphase separation structures are arranged parallel to the film surface. Further, the outermost surface of the film contacts with the air or a substrate, so it is covered with the component having the highest affinity for the air or substrate out of the components forming the block copolymer. Accordingly, the channel structure described above is not uncovered to the surface.

As described above, it is extremely difficult to orient the microphase separation structures perpendicularly to the film surface; particularly in the case of a film having a thickness of 1 μm or more, such orientation has been realized only in Japanese Patent Application Laid-Open No. 2006-299106. Japanese Patent Application Laid-Open No. 2006-299106 discloses the following approach to produce a film having cylindrical structures oriented perpendicularly to its surface, though the approach is applicable only to a cylindrical structure: a spherical microphase separation structure is formed in the film, and then the spherical structure is caused to coalesce only in the perpendicular direction under specific conditions so as to undergo a phase transition to the cylindrical structures.

However, the approach disclosed in Japanese Patent Application Laid-Open No. 2006-299106 has such a drawback that upon achievement of the phase transition from the spherical structures to the cylindrical structures, extremely strict experimental conditions need to be set.

First, the phase transition from the spherical structures to the cylindrical structures is an essential condition, but spheres positioned so as to be closest to each other coalesce at the time of the phase transition to undergo a transition to a cylindrical structure. Accordingly, when the spheres are disorderedly present in the film without being arranged, the orientations of the cylindrical structures after the phase transition are not aligned. In other words, in order that the orientations of the cylindrical structures after the phase transition are controlled, the spherical structures before the phase transition need to be arranged over the entirety of the film surface in the form of lattices so that the distance between adjacent spheres may be controlled. However, it is extremely difficult to arrange the spherical structures over the entirety of the film surface.

Second, adjacent spherical structures need to be caused to coalesce only in the direction perpendicular to the film surface. When the spherical structures of a block copolymer are arranged in the form of lattices, the spherical structures are known to form a body-centered cubic lattice. In the case of the body-centered cubic lattice, however, one sphere is adjacent to eight spheres, so it is not guaranteed that spheres coalesce in one direction out of the eight directions, that is, only in the direction perpendicular to the film surface selectively.

Third, even when perpendicularly oriented cylindrical structures are achieved, the outermost surface of the film is covered with the component having the highest affinity for the air or a substrate out of the components forming the block copolymer, in other words, a skin layer is formed on the surface of the film, so none of the cylindrical structures penetrates both surfaces of the film.

As described above, the approach disclosed in Japanese Patent Application Laid-Open No. 2006-299106 is not a realistic approach because the approach provides cylindrical structures oriented perpendicularly to the film surface only under extremely limited conditions. Further, the presence of the skin layer on the surface precludes the exposure of a component forming the cylindrical structure to the surface of the film.

### DISCLOSURE OF THE INVENTION

The present invention has been made in view of such background art, and an object of the present invention is to provide a block copolymer film having the following characteristics and a method of producing the film by employing an more simple approach. The inventive film has the structure in which cylindrical structures are oriented in the direction perpendicular to the film surface, and all polymer components forming a block copolymer are uncovered to the surface of the film.

A block copolymer film which can solve the above-mentioned problems is characterized in that the block copolymer film comprises a block copolymer, wherein a microphase separation structure formed by the block copolymer is oriented in a direction perpendicular to a film surface; and all polymer components forming the block copolymer are uncovered to the film surface.

At least one polymer component forming the block copolymer preferably has a glass transition temperature of 30° C. or higher.

The microphase separation structure preferably comprises cylindrical structures.

A method of producing a block copolymer film which can solve the above-mentioned problems is a method of producing a film comprising a block copolymer, the method comprising extruding a melt of the block copolymer in one direction by one of extrusion molding and injection molding; cooling the extruded block copolymer to a temperature equal to or lower than glass transition temperatures of polymer components in the block copolymer to provide one of a prismatic extrusion molded product and a cylindrical extrusion molded product; and cutting one of the prismatic extrusion molded product and the cylindrical extrusion molded product in a direction perpendicular to an extrusion direction.

The molding temperature during the extrusion molding or the injection molding is preferably equal to or higher than the glass transition temperature of each polymer component forming the block copolymer, and is preferably equal to or lower than an order-disorder transition temperature of the block copolymer.

The block copolymer used in one of the extrusion molding and the injection molding preferably contains 30 wt % or less of a solvent.

The cutting is performed with a microtome, and the film obtained by the cutting has a thickness of 0.1 μm or more and 1 mm or less.

According to the present invention, there can be provided by a simple production method a polymer functional film having such a characteristic that a microphase separation structure formed by a block copolymer is arranged in a direction perpendicular to the film surface, and all polymer components forming the block copolymer are uncovered to the film surface, whereby the microphase separation structure penetrates the film surface.

The functional film thus obtained can be utilized in, for example, a high-selectivity separation film, a filter, a nanoporous film, an electrolyte film for a cell, a separator for a cell, a template for patterning, or a mold for nanoimprinting.

Further features of the present invention will become apparent from the following description of the exemplary embodiments with reference to the attached drawings.

### BRIEF DESCRIPTION OF THE DRAWINGS

FIG. 1 is a view schematically illustrating an embodiment of a method of producing a block copolymer film of the present invention.

FIG. 2 is a transmission electron microscope (TEM) image of a microphase separation structure in a block copolymer film obtained in Example 1.

FIG. 3 is a transmission electron microscope (TEM) image of the microphase separation structure in the block copolymer film obtained in Example 1.

FIG. 4 is a transmission electron microscope (TEM) image of the microphase separation structure on the surface of the block copolymer film obtained in Example 1.

FIG. 5 is a transmission electron microscope (TEM) image of a microphase separation structure in a block copolymer film obtained in Comparative Example 1.

FIG. 6 is a transmission electron microscope (TEM) image of a microphase separation structure on the surface of a block copolymer film obtained in Comparative Example 2.

### BEST MODE FOR CARRYING OUT THE INVENTION

Hereinafter, the present invention is described in detail.

A block copolymer film according to the present invention is a film formed of a block copolymer characterized in that a microphase separation structure formed by the block copolymer is oriented in the direction perpendicular to the film surface; and all polymer components forming the block copolymer are uncovered to the surface of the film.

The present invention relates to a film having the following characteristics and a method of producing the film. The inventive film has such a structure that a microphase separation structure is oriented in the direction perpendicular to the film surface, and all polymer components forming a block copolymer are uncovered to the surface of the film.

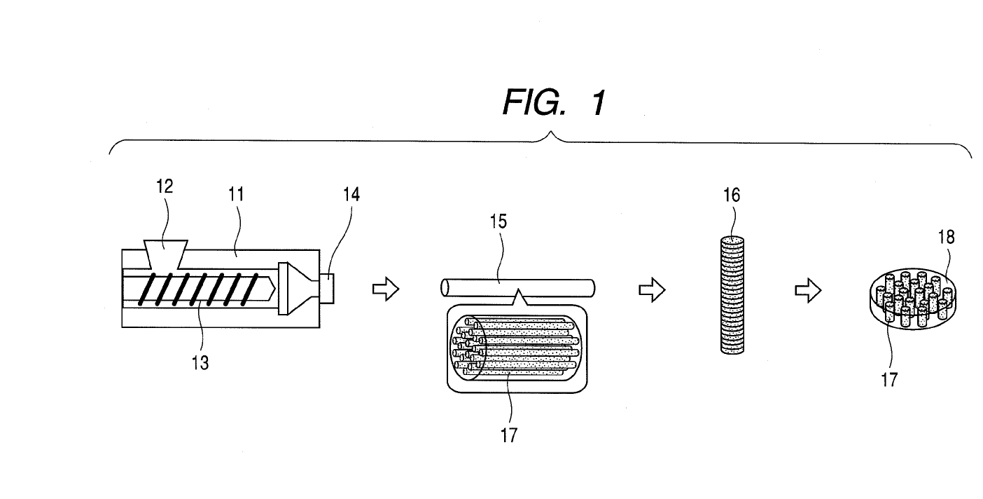

FIG. 1 is a view schematically illustrating a block copolymer film in which cylindrical structures are oriented perpendicularly to the film surface as an embodiment of the present invention, and a method of producing the film. In the figure, an extrusion molding machine 11 used in the present invention kneads and melts a block copolymer loaded from a hopper 12 with a screw 13, and extrudes the molten product in one direction from a die 14 to provide an extrusion molded product 15. Cylindrical structures 17 each of which has received a shearing stress at the time of the extrusion in the extrusion molded product 15 are oriented in the extrusion direction. The extrusion molded product 15 is cut in the direction perpendicular to the extrusion direction, whereby a block copolymer film 18 in which the cylindrical structures 17 are oriented perpendicularly is obtained. It should be noted that the extrusion molded product is cut with a slicer to provide a cut extrusion melt 16.

### (Re: Block Copolymer)

The block copolymer used in the present invention is not particularly limited as long as the block copolymer can be kneaded with an extrusion molding machine or an injection molding machine. Although the following description specializes in an A-B diblock copolymer formed of a first segment (A) and a second segment (B), the block copolymer may be a block copolymer of an A-B-X type or B-A-X type in which another polymer chain X is connected to one terminal of the polymer chain of the A-B diblock copolymer. The polymer chain X is, for example, a polymer C, a C-D diblock copolymer, or a polymer A or B. The above polymer C or D is not particularly limited no matter what property the polymer has. Further, a triblock copolymer of the A-B-A type or B-A-B type is better than the A-B type diblock copolymer because the dynamic strength of a film when the triblock copolymer is used in the film is higher than that of a film using the A-B type diblock copolymer. In addition, the block copolymer in the present invention is of a concept including a star block copolymer in which multiple dissimilar polymers are connected to one chemical bonding point and a graft copolymer in which multiple dissimilar polymers are connected to side chains of one polymer chain. In addition, a gradient copolymer having a polymer chain in which the composition of the components A and B shows a gradient is also permitted.

A third component may be added to the block copolymer. For example, a homopolymer formed of the same component as that of the polymer chain forming the block copolymer, any one of the various additives such as a plasticizer, an antioxidant, a radical scavenger, a light stabilizer, a dye, and a crosslinking agent, or any one of the various catalysts may be added.

Each polymer component forming the block copolymer is not particularly limited as long as the polymer component can synthesize the block copolymer, and can form a film structure.

Examples thereof include polymers synthesized from monomers such as acrylates, methacrylates, styrene derivatives, conjugate dienes, and vinyl ester compounds.

Examples of other monomers that can be used in the block copolymer of the present invention include styrene, and styrene substituted with α-, o-, m-, and p-alkyl, alkoxyl, halogen, haloalkyl, nitro, cyan, amide, or ester.

In addition, polymerizable unsaturated aromatic compounds, alkyl(meth)acrylates, fluoroalkyl(meth)acrylates, siloxanyl compounds, amine-containing (meth)acrylates, unsaturated alcohols, epoxy-group-containing (meth)acrylates, monoesters or diesters of epoxy-group-containing (meth)acrylates, maleimides, (meth)acrylonitrile, vinyl chloride, and the like can also be used as other monomers used in the block copolymer.

The molecular weight of the block copolymer of the present invention is not particularly limited as long as the microphase separation structure is formed. However, the number-average molecular weight of the block copolymer here is desirably 10,000 or more because the higher the molecular weight, the stronger a film formed of the block copolymer. The number-average molecular weight can be measured by gel permeation chromatography (GPC).

A combination of the polymer components used in the block copolymer of the present invention is not particularly limited. However, when the glass transition temperature of each polymer component forming the block copolymer is lower than a use temperature of the film, the microphase separation structure can flow even after the production of the film, so the internal structure of the film may change. Accordingly, one polymer component forming the block copolymer desirably has a glass transition temperature of 30° C. or higher. The term “change in the internal structure of the film” as used herein refers to, for example, the covering of the outermost surface of the film with a component having a high affinity for an air surface, in other words, the formation of a skin layer on the film surface.

In addition, the extrusion molded product needs to be cut with a cutting apparatus such as a microtome upon production of the film with the production method of the present invention. Accordingly, as in the case of the foregoing, one polymer component forming the block copolymer desirably has a glass transition temperature of 30° C. or higher. In the case where all polymer components forming the block copolymer each have a glass transition temperature of 30° C. or lower, or particularly 0° C. or lower, the extrusion molded product may deform at the time of a cutting process. Accordingly, in this case, the extrusion molded product needs to be frozen with liquid nitrogen at a temperature equal to or lower than the glass transition temperature of each polymer component forming the block copolymer before being subjected to a cutting operation. On the other hand, when one polymer component forming the block copolymer has a glass transition temperature of 30° C. or higher, the component becomes in a glassy state at a temperature around room temperature, so there is no need to use a coolant such as liquid nitrogen at the cutting step, and hence the operation becomes easy. As long as the film is used at normal temperature, there is no possibility that the microphase separation structure changes. The glass transition temperature of each polymer component forming the block copolymer can be measured with a differential scanning calorimeter (DSC).

Examples of the combination of the polymers A and B of the A-B diblock copolymer satisfying the above conditions include block copolymers having the following combinations: a styrene-based polymer and a diene-based polymer; a styrene-based polymer and an olefin-based polymer; a styrene-based polymer and an acrylic polymer; a styrene-based polymer and an ester-based polymer; an olefin-based polymer and a diene-based polymer; an olefin-based polymer and an acrylic polymer; an olefin-based polymer and an ester-based polymer; an acrylic polymer and a diene-based polymer; an acrylic polymer and an ester-based polymer; and an ester-based polymer and a diene-based polymer.

The microphase separation structure formed by the A-B diblock copolymer is generally of, for example, spherical structures, cylindrical structures, network structures, or lamellar structures; structures having anisotropy can also be arranged in the direction perpendicular to the film surface by the production method of the present invention. Accordingly, out of the above microphase separation structures, although those of the cylindrical structures and the lamellar structures satisfy the condition, the microphase separation structure is preferably of the cylindrical structures in many cases when one attempts to utilize the film as a functional film. This is because when one attempts to utilize the film as a separator for a cell, a separation film, or a filter, the film needs to be turned into a porous film by decomposing and removing one component of the copolymer, but, in the case of the lamellar structures, a matrix phase remaining after the decomposition and removal does not become a continuous phase, so a film structure cannot be maintained. Hereinafter, in the present invention, description is given by taking the cylindrical structures as examples.

In order that the cylindrical structures are produced, in the case of, for example, the A-B diblock copolymer, it is only necessary to control the volume ratio between the components A and B. To be specific, it is satisfactory that the volume fraction “component A/component B” between the components A and B be set to fall within the range of 15/85 (85/15) to 40/60 (60/40), or more preferably 20/80 (80/20) to 35/75 (75/35); in which the numerical value in the parentheses described above corresponds to the case where the volume ratio between the components A and B is inverted.

In addition, when the melt of the block copolymer is produced by using a solvent and is subjected to extrusion molding, the microphase separation structure is determined by the volume ratio of the block copolymer and the affinity between each polymer component forming the block copolymer and the solvent. Accordingly, the formation of the cylindrical structures in a state where the block copolymer contains the solvent eliminates the need of controlling the volume fraction within the above range.

It should be noted that the volume fraction of the block copolymer can be calculated from the composition ratio (weight ratio) between the components A and B forming the block copolymer and the density of each polymer component. The composition ratio can be determined by nuclear magnetic resonance (NMR) measurement. Alternatively, the volume ratio of the block copolymer can be directly determined by a three-dimensional observation of a microphase separation structure using electron beam tomography.

### (Method of Producing Block Copolymer Film)

Next, the method of producing a block copolymer film of the present invention is described.

The production method of the present invention includes the following three steps:

(1) the step of extruding a melt of a block copolymer in one direction by extrusion molding or injection molding;
(2) the step of cooling the extruded block copolymer to a temperature equal to or lower than the glass transition temperatures of polymer components in the block copolymer to provide a prismatic or cylindrical extrusion molded product; and
(3) the step of cutting the prismatic or cylindrical extrusion molded product in a direction perpendicular to the extrusion direction.

It is preferred that the molding temperature during the extrusion molding or injection molding be equal to or higher than the glass transition temperature of each polymer component forming the block copolymer and be equal to or lower than the order-disorder transition temperature of the block copolymer.

The block copolymer used in the extrusion molding or injection molding preferably contains 30 wt % or less of a solvent.

One of the extrusion molding and the injection molding can be employed in the production method of the present invention; hereinafter, details about the respective steps are described by taking the extrusion molding as an example.

### (1) Step of Extruding Melt of Block Copolymer in One Direction by Extrusion Molding or Injection Molding

Heating the block copolymer or mixing the block copolymer with a solvent suffices for the production of the melt of the block copolymer; in the production method of the present invention, however, it is important for the block copolymer to undergo microphase separation in a molten state. When the block copolymer undergoes microphase separation in a molten state, the melt of the block copolymer is affected by shearing stress at the time of the extrusion, whereby the cylindrical structures are oriented in the extrusion direction.

The heating temperature in the case where the block copolymer is melted by a heating treatment cannot be uniquely determined because the heating temperature depends on the kind of the block copolymer and the conditions under which the block copolymer is extruded; in general, it is satisfactory that the heating temperature be set to fall within the temperature range from a temperature equal to or higher than the glass transition temperature or melting point of each polymer component in the block copolymer to a temperature equal to or lower than the temperature below which the microphase separation structure of the block copolymer is not broken (order-disorder transition temperature). It should be noted that the production method of the present invention is applicable even at a temperature equal to or higher than the order-disorder transition temperature of the block copolymer in some cases because the microphase separation is induced by an influence of the flow caused in the extrusion.

Further, with decreasing viscosity of the melt, the flowability of each of the microphase separation structures becomes higher, and hence the cylindrical structures are more easily oriented by the extrusion molding. Accordingly, the extrusion temperature is desirably as high as possible on condition that the extrusion temperature is equal to or lower than the order-disorder transition temperature. The glass transition temperature and melting point of each component forming the block copolymer can be measured with a differential scanning calorimeter (DSC). The order-disorder transition temperature can be identified by tracking the change of each microphase separation structure in association with a temperature change by small-angle X-ray scattering (SAXS) measurement.

The viscosity of the melt depends on the specifications of an extrusion molding machine; however, the viscosity is not particularly limited as long as the melt can be subjected to extrusion molding and an extrusion molded product obtained from the discharge port of an extruding die has no voids and is homogeneous. As described above, however, the lower the viscosity of the melt is, the more susceptible to orientation by the extrusion the cylindrical structures are, so the viscosity is preferably as low as possible. In general, the viscosity is desirably 2,000 Pa·s or less; particularly when the viscosity is 1,500 Pa·s or less, the cylindrical structures are easily oriented, and the extrusion molding is facilitated. The viscosity of the block copolymer can be easily measured with a rotational viscometer.

The melt may be obtained by mixing a block copolymer and a solvent. In this case as well, extrusion molding is required to be performed under such conditions that the block copolymer undergoes microphase separation. As long as the conditions under which microphase separation structures are present are established, a mixture of the block copolymer and the solvent may be further subjected to a heating treatment. The presence or absence of microphase separation structures can be confirmed by the following procedure: a solution having the same concentration as that of the block copolymer solution used in extrusion molding is prepared, and the presence or absence of microphase separation structures in the solution is confirmed by the above-mentioned small-angle X-ray scattering measurement.

With regard to the viscosity of the melt, as in the case of the extrusion molding by a heating treatment, as long as the block copolymer undergoes microphase separation in the block copolymer solution, the lower the viscosity of the solution is, the higher orienting effect on the cylindrical structures the extrusion exerts. In general, the viscosity of the solution is preferably 2,000 Pa·s or less, or more preferably 1,500 Pa·s or less.

When a solvent is added, the solvent remains in the extrusion molded product after the extrusion. When the amount of the solvent to be added is large, air bubbles may be produced in the film by the evaporation of the solvent after the production of the film, so the amount of the solvent to be added is desirably as small as possible; the weight proportion of the solvent to the block copolymer is 30 wt % or less, or more preferably 10 wt % or less. When one wishes to suppress the evaporation of the solvent remaining in the extrusion molded product, a high-boiling solvent or a plasticizer may be used. The high-boiling solvent that can be used here has a boiling point of 100° C. or higher, preferably 150° C. or higher, or more preferably 200° C. or higher.

Examples of the high-boiling solvent that can be used in the present invention include, but of course are not limited to, N-methyl formamide, N,N-dimethyl formamide, N-methyl formanilide, N-methyl formanilide, N,N-dimethyl acetoamide, N-methyl pyrrolidone, dimethyl sulfoxide, ethylene glycol monomethylether acetate, propylene glycol monomethylether acetate, cyclohexanone, benzylethyl ether, dihexyl ether, acetonyl acetone, isophorone, caproic acid, caprylic acid, 1-octanol, 1-nonanol, benzyl alcohol, benzyl acetate, ethyl benzoate, diethyl oxalate, diethyl maleate, γ-butyrolactone, ethylene carbonate, propylene carbonate, and phenyl cellosolve acetate. Examples of the plasticizer include phthalates, adipates, polyadipates, trimellitates, citrates, and phosphates.

With regard to the kind of the solvent, for example, in the case where a A-B diblock copolymer the component A of which forms cylindrical structures is used, a solvent having a high affinity for the component B that forms the matrix phase is desirably used, because the regularity of the cylindrical structures after the extrusion molding is improved. In this case, the added solvent is localized mainly to the matrix phase of the block copolymer, so the flowability of the cylindrical structures in the solution is improved, and hence the cylindrical structures become susceptible to orientation control by the extrusion molding.

The affinity between the polymer and the solvent can be represented in terms of solubility parameter; the smaller a difference in solubility parameter between the polymer and the solvent, the higher the affinity between them. Accordingly, the solvent has a higher affinity for the component B than for the component A when a difference in solubility parameter between the component B and the solvent is smaller than a difference in solubility parameter between the component A and the solvent. In addition, even in the case where the above condition is satisfied, when the difference in solubility parameter between the component B and the solvent is 5 MPa^{1/2} or more, the block copolymer itself does not dissolve in the solvent, so the difference is desirably 5 MPa^{1/2} or less, or preferably 3 MPa^{1/2} or less. It should be noted that values for solubility parameters are described in Brandrup, E.; Immergut, E. H. Polymer Handbook Third Edition, John Willy & Sons, New York.

(2) Step of Cooling Extruded Block Copolymer to Temperature Equal to or Lower than Glass Transition Temperature of Polymer Component in Block Copolymer to Provide Prismatic or Cylindrical Extrusion Molded Product

The design of a discharge port of a die is very important in the production method of the present invention because the shape and size of the film are determined by the shape and diameter of the discharge port of the die. When one wishes to produce a circular film, the discharge port of the die needs to have a cylindrical shape; when one wishes to produce a prismatic film, a prismatic die discharge port has to be used.

When the size of the film to be finally obtained is increased, the discharge port diameter of the die has to be increased. However, when the discharge port diameter is increased, the block copolymer becomes less susceptible to the shearing stress at the time of the extrusion, with the result that the cylindrical structures are not sufficiently oriented. Accordingly, the discharge port diameter in the present invention is desirably 50 mm or less, preferably 30 mm or less, or more preferably 10 mm or less.

When the extrusion molded product obtained by the molding is cooled to a temperature equal to or lower than the glass transition temperature of each polymer component forming the block copolymer, the microphase separation structure in the film is frozen. Accordingly, the extrusion molded product is to be frozen by being extruded from the discharge port of the die into air or water.

### (3) Step of Cutting Prismatic or Cylindrical Extrusion Molded Product in Direction Perpendicular to Extrusion Direction

According to the production method of the present invention, a prismatic or cylindrical extrusion molded product is cut with a slicer at an arbitrary interval, whereby the block copolymer film in which cylindrical structures are oriented perpendicularly to the film surface is obtained. The thickness of the block copolymer film is determined by the interval at which the extrusion molded product is cut with the slicer, so the thickness of the block copolymer film is not limited as long as the cutting can be performed.

The thickness of the polymer film when the polymer film is used as a functional film generally falls within the range of 0.1 μm or more to 1 mm or less. When the extrusion molded product is cut at an interval of 1 μm or more and 1 mm or less, a microtome with which a cutting thickness can be accurately controlled is desirably used. For example, when a rotary microtome manufactured by Leica Microsystems is used, the block copolymer film can be easily produced at room temperature as long as the thickness falls within the above range. When both the polymer components forming the block copolymer each have a glass transition temperature of 30° C. or lower, the microtome manufactured by Leica Microsystems Co. is provided with a cryostage and the extrusion molded product is cut with the microtome while being cooled with liquid nitrogen.

The block copolymer film is generally produced by dissolving the block copolymer in an organic solvent; applying the solution onto a substrate; and evaporating the solvent. In this case, any one of the application approaches such as a spin coating method, a dipping method, a roll coating method, a spray method, and a cast method can be employed as a method for the application. However, a film obtained by any one of those film formation methods is necessarily affected by the surface of the substrate and the surface of air at the time of the film formation. In other words, the surface of the film is covered with a component in the block copolymer having a high affinity for the air or substrate, whereby a skin layer is formed. As a result, both the polymer components forming the block copolymer are not uncovered to the surface.

On the other hand, when the block copolymer film is produced by employing the production method of the present invention, a section obtained by cutting with a slicer such as a microtome directly serves as the surface of the film. Accordingly, as a necessary consequence of this method, no skin layer is present, and, when the cylindrical structures are oriented perpendicularly to the film surface, both polymer components, i.e., the component forming cylindrical structure and the component forming the matrix are necessarily uncovered to the surface of the film. The film thus obtained is extremely effective when one attempts to utilize the film as a functional film because the cylindrical structures penetrate both surfaces of the film.

The presence of the skin layer on the surface of the film is preferably confirmed by observing the surface structure of the film with a transmission electron microscope; it is more preferred that a three-dimensional structure on the surface of the film be directly observed by utilizing electron beam tomography. Further, the presence of the skin layer can be confirmed by observing the composition distribution in the depth direction of the film by means of dynamic secondary ion mass spectrometry (DSIMS).

As described above, a block copolymer film in which microdomain structures are oriented in the direction perpendicular to the film surface and all components forming a block copolymer are uncovered to the surface of the film can be easily produced by employing the production method of the present invention.

Next, a first embodiment of the block copolymer film of the present is described.

A film-electrode assembly as one embodiment of the present invention can be produced by placing electrodes on the block copolymer film produced by the production method of the present invention. The film-electrode assembly is formed of the block copolymer film of the present invention, and catalyst electrodes (an anode and a cathode) opposed to each other sandwiching the film, wherein the catalyst electrodes each have a gas diffusion layer and a catalyst layer formed on the gas diffusion layer. A method of producing the assembly is not particularly limited, and a known technique can be employed. For example, the assembly can be produced by any one of the following methods: a method involving directly forming, on the block copolymer film, a gas diffusion electrode with a catalyst of platinum, a platinum-ruthenium alloy or a product which is obtained by dispersing fine particles of platinum or a platinum-ruthenium alloy onto a carrier such as carbon to cause the carrier to carry the metal; a method involving subjecting a gas diffusion electrode and the block copolymer film to hot pressing; and a method involving joining the electrodes and the film with a bonding liquid.

In addition, a fuel cell can be produced with the film-electrode assembly by a known approach. The constitution of the fuel cell is, for example, the film-electrode assembly, a pair of separators for sandwiching the film-electrode assembly, or a structure including a collector attached to a separator, and a packing. The separator on an anode side is provided with an anode side opening, and a gas fuel or liquid fuel made of hydrogen or an alcohol such as methanol is supplied from the opening. On the other hand, the separator on a cathode side is provided with a cathode side opening, and an oxidizing gas such as an oxygen gas or air is supplied from the opening.

Next, a second embodiment of the block copolymer film of the present invention is described.

A porous film, as the second embodiment of the present invention, can be produced by decomposing and removing the cylindrical structures in the block copolymer film to turn the cylindrical structures into voids. An approach to decomposing and removing the cylindrical structures is, for example, a method involving the utilization of a photodecomposition reaction or ozonolysis, a method of decomposing the cylindrical structures by utilizing an energy ray typified by an α ray, a β ray (electron beam), a γ ray, a neutron ray, or an X-ray, a melting method involving the use of an acid or alkali, or a method involving the utilization of an etching process typified by dry etching or wet etching. The produced porous film can be used in, for example, a separator for a cell, an ultrafiltration film, a microfiltration film, a separation film, a bioreactor film, or a mold for nanoimprinting.

Next, a third embodiment of the block copolymer film of the present invention is described.

A patterning substrate having a recessed portion or protruded portion thereon, as the third embodiment of the present invention, can be produced by utilizing the porous film obtained in the second embodiment as a template. The term “recessed portion” as used herein refers to a pattern formed by etching a void portion of the polymer porous film. On the other hand, the term “protruded portion” as used herein refers to a pattern formed by etching a portion except the void portion of the polymer porous film.

The substrate used in the present invention is, for example, a silicon single crystal substrate, an amorphous silicon substrate, or a metal substrate, but is not limited to them. For example, when the substrate is made of silicon, the following procedure can be applicable: a silicon layer is subjected to dry etching with an SF₆/CHF₃ mixed gas by using the polymer porous film as a mask so that the pattern of the mask can be transferred onto the silicon substrate. As long as the pattern of the mask can be transferred onto the silicon substrate with high accuracy, the gas species used at the time of the dry etching is not particularly limited to the SF₆/CHF₃ mixed gas, and a combination of two or more of, for example, SF₆, CHF₃, C₄F₈, CF₄, and O₂ may be used.

In the case where a patterning substrate having a protruded portion is produced, the substrate is etched by using another material as a mask instead of the block copolymer. In this case, a metal is deposited onto the polymer porous film on the substrate. The metal to be deposited can be any metal that satisfies the condition that the metal resists the etching process and can be well removed from the substrate after the dry etching. For example, chromium is used as the metal.

After the above deposition step, the block copolymer and the deposited substance formed on the block copolymer are removed. This step is achieved by washing out the block copolymer remaining on the substrate with a solvent for dissolving the block copolymer. By this step, the deposited substance can be left only at a portion where the block copolymer as a mask component on the substrate is absent. After that, the above dry etching is to be performed.

### EXAMPLES

Hereinafter, the present invention is specifically described by way of examples. However, the present invention is not limited to these examples.

### Block Copolymer 1

### PS-PEP-PS Triblock Copolymer

A polystyrene (PS)-polyethylene propylene (PEP)-polystyrene (PS) triblock copolymer (composition ratio: PS/PEP=30/70) was used as a block copolymer 1. The molecular weight of the copolymer was identified by gel permeation chromatography (GPC). As a result, the copolymer had a number-average molecular weight (Mn) of 64,600 and a degree of polydispersity (Mw/Mn) of 1.06.

Polystyrene (PS) has a glass transition temperature of 100° C., and polyethylene propylene (PEP) has a glass transition temperature of −75° C.

### Example 1

100 g of the PS-PEP-PS triblock copolymer of the block copolymer 1 was formed into a cylindrical extrusion molded product with an extrusion molding machine provided with a die having a discharge port diameter of 10 mm. The extrusion molding was performed under the following conditions: the extrusion speed was set to 30 cm/min, and the cylinder temperature in the machine and the temperature of the die were each set to 200° C. It should be noted that the resultant sample forms a cylindrical microphase separation structure at the extrusion temperature, i.e., 200° C., because it has been already confirmed that the order-disorder transition temperature of the PS-PEP-PS triblock copolymer is 200° C. or higher by small-angle X-ray scattering (SAXS) measurement.

The PS-PEP-PS triblock copolymer extruded in a cylindrical form from a die head was cooled in air, whereby a solid extrusion molded product was obtained. The resultant cylindrical extrusion molded product was cut with a microtome manufactured by Leica Microsystems Co. at room temperature and an interval of 40 μm, whereby a film of the same size (10 mmφ) as the discharge port diameter was obtained.

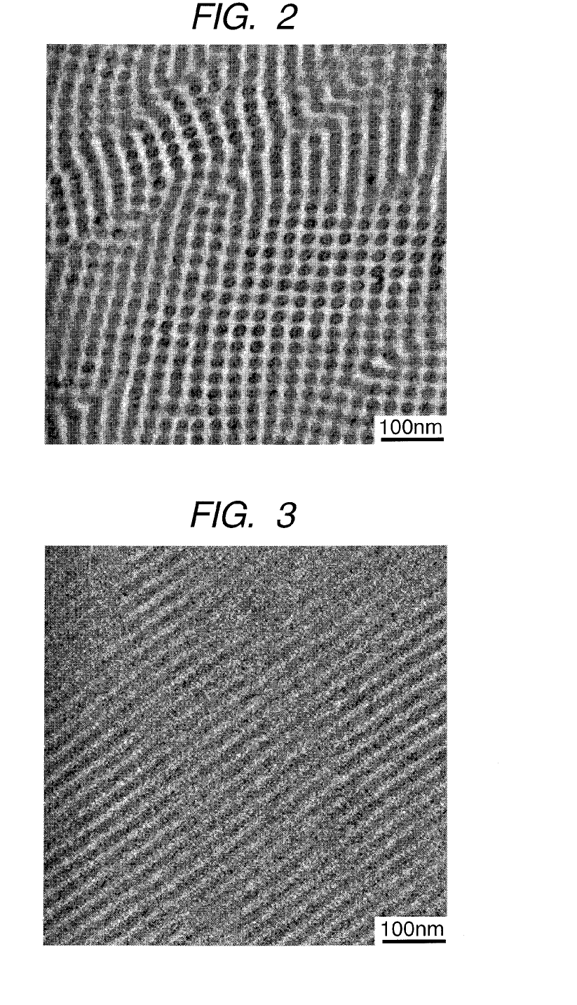

FIGS. 2 and 3 show the results of the observation of the inside of the resultant film with a transmission electron microscope (TEM). Ultra-thin slices were cut out of the film in directions perpendicular to and horizontal to the extrusion direction, and the slices were subjected to vapor staining with ruthenium tetroxide. In the staining method, the PS component is observed to be dark. FIG. 2 is the TEM image of the ultra-thin slice cut out in the direction perpendicular to the extrusion direction; here, the circular sections of the cylindrical microphase separation structure were observed over the entirety of the film surface. On the other hand, FIG. 3 shows the TEM image of the ultra-thin slice cut out in the direction horizontal to the extrusion direction; here, a linear repeating structure in which the cylindrical microphase separation structure lay parallel to the observed surface was observed. The foregoing results showed that the sample formed the cylindrical microphase separation structure, and that the cylindrical structures were oriented perpendicularly to the film surface.

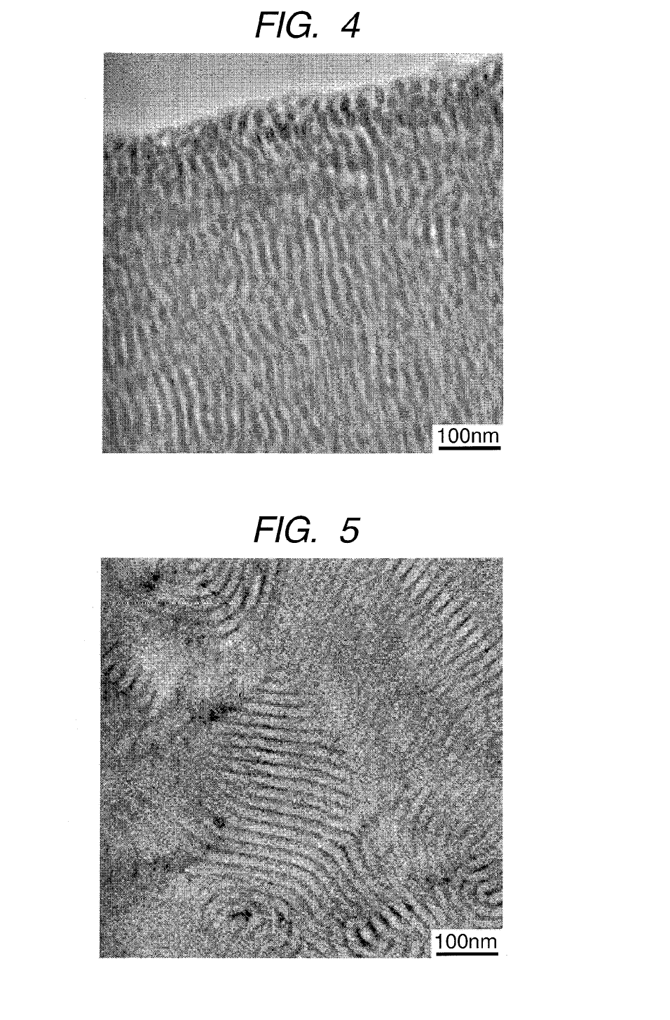

FIG. 4 shows the result of the observation of the outermost surface of the produced film with a TEM. FIG. 4 is a TEM image of an ultra-thin slice cut out in the direction horizontal to the extrusion direction, in other words, in the sectional direction of the film and subjected to vapor staining with ruthenium tetroxide. As shown in the image, the cylindrical microphase separation structures observed to be dark, was uncovered to the outermost surface of the film, and the cylindrical structures were arranged so as to penetrate both surfaces of the film.

### Example 2

70 g of the PS-PEP-PS triblock copolymer of the block copolymer 1 and 30 g of dioctyl phthalate were formed into a cylindrical extrusion molded product with an extrusion molding machine provided with a die having a discharge port diameter of 10 mm. The extrusion molding was performed under the following conditions: the extrusion speed was set to 30 cm/min, and the cylinder temperature in the machine and the temperature of the die were each set to 80° C. Preliminary SAXS measurement had confirmed that a mixture of the PS-PEP-PS triblock copolymer and dioctyl phthalate forms a cylindrical microphase separation structure at the extrusion temperature, i.e., 80° C.

The mixture of the PS-PEP-PS triblock copolymer and dioctyl phthalate extruded in a cylindrical form from the die head was cooled in air, whereby a solid extrusion molded product was obtained. The resultant cylindrical extrusion molded product was sliced with a microtome manufactured by Leica Microsystems Co. at room temperature and an interval of 40 μm, whereby a film of the same size (10 mmφ) as the discharge port diameter was obtained.

Ultra-thin slices were cut out of the resultant film in directions horizontal to and perpendicular to the extrusion direction, and the structure inside the film was observed with a TEM. As a result, the cylindrical structures were observed to be oriented perpendicularly to the film surface. In addition, the outermost surface of the produced film was observed with a TEM. As a result, it was found that the cylindrical microphase separation structure was uncovered to the outermost surface of the film, and the cylindrical structures were arranged so as to penetrate both surfaces of the film.

### Comparative Example 1

The PS-PEP-PS triblock copolymer of the triblock copolymer 1 was dissolved in toluene so that a 5-wt % solution was prepared. After that, the solution was formed into a film by a solvent cast method. The film after the film formation process had a thickness of 50 μm. FIG. 5 shows the result of the observation of the inside of the resultant film with a TEM. The result, which was the result of the observation of the section of the film obtained by the solvent cast method with the TEM, confirmed that the PS component stained with ruthenium tetroxide so as to be dark formed a cylindrical microphase separation structure, but the cylindrical structures were not arranged in a predetermined direction but were unoriented.

### Comparative Example 2

The PS-PEP-PS triblock copolymer of the triblock copolymer 1 was dissolved in a mixed solvent obtained by mixing hexane and dichloromethane at a volume ratio of 7:3 so that a 5-wt % solution was prepared. After that, the solution was formed into a film by a solvent cast method. The film after the film formation process had a thickness of 50 μm. The inside of the resultant film was observed with a TEM. As a result, the formation of spherical structures was observed, but there were few sites where the spherical structures were arranged in the form of a body-centered cubic lattice.

Subsequently, the formed film was subjected to a heat treatment at 200° C. for 3 hours in a silicone oil, and was then cooled in ice water so that the spherical structures was caused to undergo a phase transition to cylindrical structures. The inside of the film after the transition to the cylindrical structures was observed with a TEM. As a result, as in the case of Comparative Example 1, it was confirmed that the cylindrical structures were not arranged in a predetermined direction but were unoriented.

### Comparative Example 3

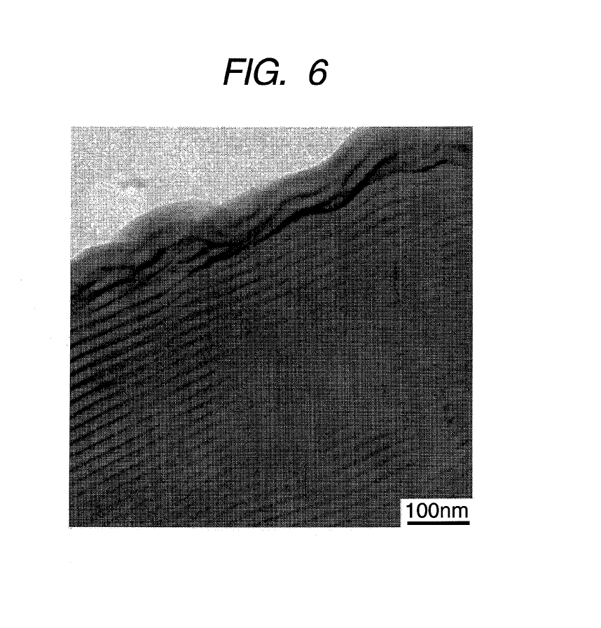

FIG. 6 shows the result of the observation of the outermost surface of the film produced in Comparative Example 2 with a TEM. FIG. 6 is a TEM image of an ultra-thin slice cut out in the sectional direction of the film and subjected to vapor staining with ruthenium tetroxide; a cylindrical microphase separation structure, observed to be dark, was arranged parallel to the film surface, and there were no sites where the cylindrical structures penetrated both surfaces of the film.

### INDUSTRIAL APPLICABILITY

The block copolymer film of the present invention is such a film that a the microphase separation structure formed by the block copolymer is arranged in the direction perpendicular to the film surface and all polymer components forming the block copolymer are uncovered to the film surface, whereby the microphase separation structure penetrates the film surface. Therefore, the block copolymer film can be utilized in, for example, a high-selectivity separation film, a filter, a nanoporous film, an electrolyte film for a cell, a separator for a cell, a template for patterning, or a mold for nanoimprinting.

While the present invention has been described with reference to the exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-143456, filed May 30, 2008, which is hereby incorporated by reference herein in its entirety.

1-4. (canceled)

5. A method of producing a block copolymer film comprising a block copolymer, comprising the steps of:
extruding a melt of the block copolymer in one direction by one of extrusion molding and injection molding;
cooling the extruded block copolymer to a temperature equal to or lower than glass transition temperatures of polymer components in the block copolymer to provide a prismatic or a cylindrical extrusion molded product; and
cutting the prismatic or cylindrical extrusion molded product in a direction perpendicular to an extrusion direction.

6. The method of producing a block copolymer film according to claim 5, wherein a molding temperature during the extrusion molding or the injection molding is equal to or higher than a glass transition temperature of each polymer component forming the block copolymer and is equal to or lower than an order-disorder transition temperature of the block copolymer.

7. The method of producing a block copolymer film according to claim 5, wherein the block copolymer used in the extrusion molding or the injection molding contains 30 wt % or less of a solvent.

8. The method of producing a block copolymer film according to claim 5, wherein the cutting step is performed with a microtome, and the film obtained by the cutting step has a thickness of 0.1 μm or more and 1 mm or less.
